(19) United States
(12) Patent Application Publication
(10) Pub. No.: US 2009/0276425 A1
(43) Pub. Date: Nov. 5, 2009

(54) ENCODING SEARCH RESULTS AS A SEARCH PERMANENT LINK UNIFORM RESOURCE LOCATOR

(76) Inventors: Anthony H. Phillips, Southampton (GB); Timothy E. Preece, Eastleigh (GB)

Correspondence Address: Dillon & Yudell LLP, 8911 N. Capital of Texas Hwy, Suite 2110, Austin, TX, 78759, US

(21) Appl. No.: 12/113,519

(22) Filed: May 1, 2008

(51) Int. Cl. G06F 17/30

(52) U.S. Cl. 707/6; 707/E17.108

(57) ABSTRACT

A method, system, and computer program product for encoding search results as a search permanent link Uniform Resource Locator (URL). The search result permanent link URL allows a user to distribute a search query that ensures that a set of search results will be the same (known as a fixed set of search result URLs) when the search query is re-run. If there is a broken search result URL link, the broken link is highlighted within a fixed set of search result URLs.

### BACKGROUND OF THE INVENTION

The present disclosure relates to permanent links, and specifically, to a method and system for encoding search results as a search permanent link Uniform Resource Locator (URL).

Permanence in links is desirable when content items are likely to be linked to, from, or cited by, a source outside the originating organization. Before the advent of large-scale dynamic websites built on database-backed content management systems, it was more common for URLs of particular pieces of content to be static and human-readable. The reason for the human-readability of URL content was largely due to the fact that URL structure and naming had been dictated by the entity creating that content. The increased volume of URL content and the associated difficulty in managing such increased volume of URL content led to the rise of database-driven systems. As a result, the unwieldy and often-changing URLs necessitated deliberate policies with regard to URL design and link permanence.

A blog entry within a blog of many entries is typically accessible from a website's front page for only a brief time. Visitors to the website who store the URL for a particular entry often find upon their return to the website that the desired content has been replaced. Prominently posting permalinks is a method employed by bloggers to encourage visitors to store a more, long-lived URL (i.e., the permalink) for reference.

A permanent link, or permalink, is a Uniform Resource Locator (URL) that points to a specific web page (e.g, a blogging entry and the like), even after the web page has passed from a front page to an archive. Since a permalink remains unchanged indefinitely, the use of permalinks avoids so-called “link rot”. Existing publishing systems and content syndication software systems, including but not limited to WordPress® (a registered trademark of Automattic Inc.), Movable Type® (a registered trademark of Six Apart Ltd.), LiveJournal™ (a trademark of Primordial Soup Ltd.), RapidWeaver™ (a trademark of RealMac software), and Blogger® (a trademark of Google, Inc.), support permalinks. While other types of websites also use permalinks, the term “permalinks” is most commonly used within the blogosphere.

Permalinks frequently include a string of characters that represent the date and time of the posted item, and an identifier which denotes the author who initially authored the posted item or the subject of the posted item. If a posted item is changed, renamed, or moved within an internal database, the link to the posted item remains unaltered. In this way, the permalink functions as a magic cookie, which references an internal database identifier. If the posted item is deleted altogether, the permalink of the deleted item is typically not reusable.

Permalinks are usually denoted by a text link (e.g., Permalink or Link to this Entry). In other cases, a symbol may be used. While the most common symbol used to denote permalinks is the hash sign, certain websites employ their own symbol convention to represent a permalink. For example, other symbols that have been used to represent a permalink include an asterisk or a dash. In other cases, unique symbols are employed. Permalinks can be indicated within the HyperText Markup Language (HTML) of a page so as to allow automated browsing tools to detect the permalink and to use the permalink for linking instead of the stated URL. Moreover, some applications allow a user to customize the structure of the permalink to improve the aesthetics and/or usability of the links.

Links to particular websites can be attained by the use of search engines. Search engines add value in several ways, in addition to their basic search function. Currently, the results that are yielded from a search engine query are transient, in that running the same query over time will produce different search results. As search engines become increasingly feature-rich, it would therefore be useful to be able to use search results as a piece of content in its own right, rather than merely a page through which resources are accessed.

### SUMMARY OF THE ILLUSTRATIVE EMBODIMENTS

In view of the foregoing, a method, system, and computer program product for encoding search results as a search permanent link Uniform Resource Locator (URL) are disclosed. The method begins by receiving a request to create the search permanent link URL from a calling application. One or more search terms referenced by the calling application are extracted. A first query is executed using one or more of the search terms, which yields at least one search result URL. A fixed set of the one or more search result URLs is then selected. A unique identifier that is associated with the search permanent link URL is generated. The unique identifier, the fixed set of the search result URLs, and the search term(s) are written to a search engine data store. The unique identifier is then returned to the calling application.

To retrieve the contents of the search permanent link URL, the search permanent link URL is received from the calling application. The unique identifier is returned to the calling application, where the unique identifier is received and extracted from the permanent link URL. The unique identifier is looked up in search engine data store and a fixed set of one or more search result URLs is retrieved from search engine data store. The fixed set that is retrieved is then added to a response message. The fixed set of search result URL(s) is/are verified to identify at least one broken link within the fixed set. If a broken link is identified, the broken link is then highlighted within the fixed set of search result URL(s). The first query is re-executed in order to yield a new set of one or more search URLs. In this regard, the search permanent link is based on the first query. The new set of search URL(s) are then added to the fixed set to generate a combined set of search result URLs. Any duplicate search result URLs are removed from the combined set to generate a revised set of search result URLs. The revised set of search result URLs is then returned to the calling application.

All objects, features, and advantages of the present invention will become apparent in the following detailed written description.

### BRIEF DESCRIPTION OF THE DRAWINGS

Aspects of the invention itself will best be understood by reference to the following detailed description of an illustrative embodiment when read in conjunction with the accompanying drawings, where:

FIG. 1 depicts an exemplary computer in which the present invention may be implemented;

FIG. 2 depicts a data communication network in which the present invention may be implemented;

FIG. 3 is a high-level flow chart depicting an exemplary method for creating a search permanent link Uniform Resource Locator (URL), according to an embodiment of the present invention; and

FIGS. 4A and 4B represent individual parts of a high-level flow chart depicting an exemplary method for retrieving the contents of a search permanent link URL, according to an embodiment of the present invention.

### DETAILED DESCRIPTION OF AN ILLUSTRATIVE EMBODIMENT

The illustrative embodiments provide a method, system, and computer program product for encoding search results as a search permanent link Uniform Resource Locator (URL). The method begins by receiving a request to create the search permanent link URL from a calling application. One or more search terms referenced by the calling application are extracted. A first query is executed using one or more of the search terms, which yields at least one search result URL. A fixed set of the one or more search result URLs is then selected. A unique identifier that is associated with the search permanent link URL is generated. The unique identifier, the fixed set of the search result URLs, and the search term(s) are written to a search engine data store. The unique identifier is then returned to the calling application.

To retrieve the contents of the search permanent link URL, the search permanent link URL is received from the calling application. The unique identifier is returned to the calling application, where the unique identifier is received and extracted from the permanent link URL. The unique identifier is looked up in search engine data store and a fixed set of one or more search result URLs is retrieved from search engine data store. The fixed set that is retrieved is then added to a response message. The fixed set of search result URL(s) is/are verified to identify at least one broken link within the fixed set. If a broken link is identified, the broken link is then highlighted within the fixed set of search result URL(s). The first query is re-executed in order to yield a new set of one or more search URLs. In this regard, the search permanent link is based on the first query. The new set of search URL(s) are then added to the fixed set to generate a combined set of search result URLs. Any duplicate search result URLs are removed from the combined set to generate a revised set of search result URLs. The revised set of search result URLs is then returned to the calling application.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

The specific numerals assigned to the elements are provided solely to aid in the description and not meant to imply any limitations (structural or functional) on the invention.

It is understood that the use of specific component, device, and/or parameter names are for example only and not meant to imply any limitations on the invention. The invention may thus be implemented with different nomenclature/terminology utilized to describe the components/devices/parameters herein, without limitation. Each term utilized herein is to be given its broadest interpretation given the context in which that term is utilized.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a tangible computer-usable storage medium having computer-usable program code embodied in the storage medium and therein processible by a computer.

Any suitable tangible computer-usable or computer-readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber cable, RF, etc.

Computer program code for carrying out operations of the present invention may be written in an object oriented programming language such as JAVA®, Smalltalk® (SMALLTALK is a trademark or registered trademark of Cincom Systems, Inc.), C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatuses (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

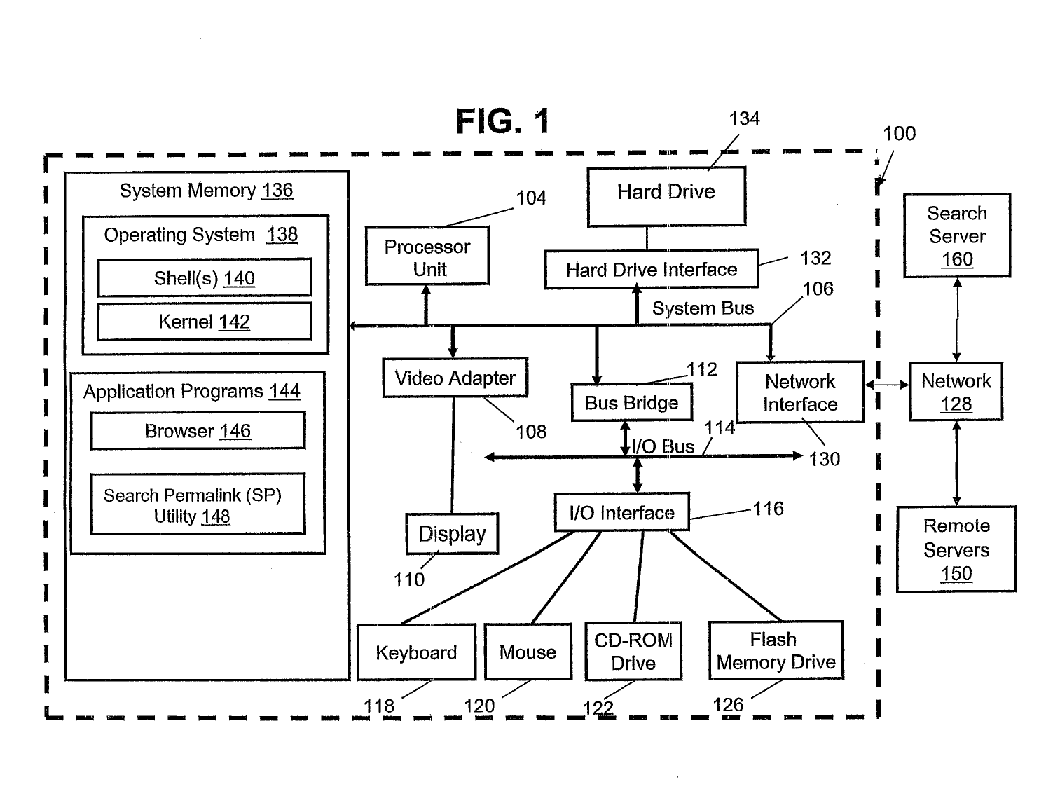

With reference now to the figures, FIG. 1 depicts a block diagram of an exemplary data processing system (DPS) (and connected network) 100, with which the present invention may be utilized. DPS 100 includes at least one processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus (USB) ports.

DPS 100 is able to communicate with a remote server 150 and a search server 160 via a network 128 using a network interface 130, which is coupled to system bus 106. Network 128 may be an external network such as the Internet, or an internal network such as an Ethernet or a Virtual Private Network (VPN). Remote server 150 and search server 160 may be architecturally configured in the manner depicted for DPS 100.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in DPS 100. This volatile memory may include additional higher levels of volatile memory (not shown), including, but not limited to, cache memory, registers, and buffers. Code that populates system memory 136 includes an operating system (OS) 138 (e.g., Microsoft Windows®, a registered trademark of Microsoft Corp., GNU®/Linux®, registered trademarks of the Free Software Foundation and Linus Torvalds, or AIX®, a registered trademark of IBM) and application programs 144.

OS 138 includes a shell 140, for providing transparent user access to resources such as application programs 144. Generally, shell 140 (as it is called in UNIX® (UNIX is a registered trademark of The Open Group)) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

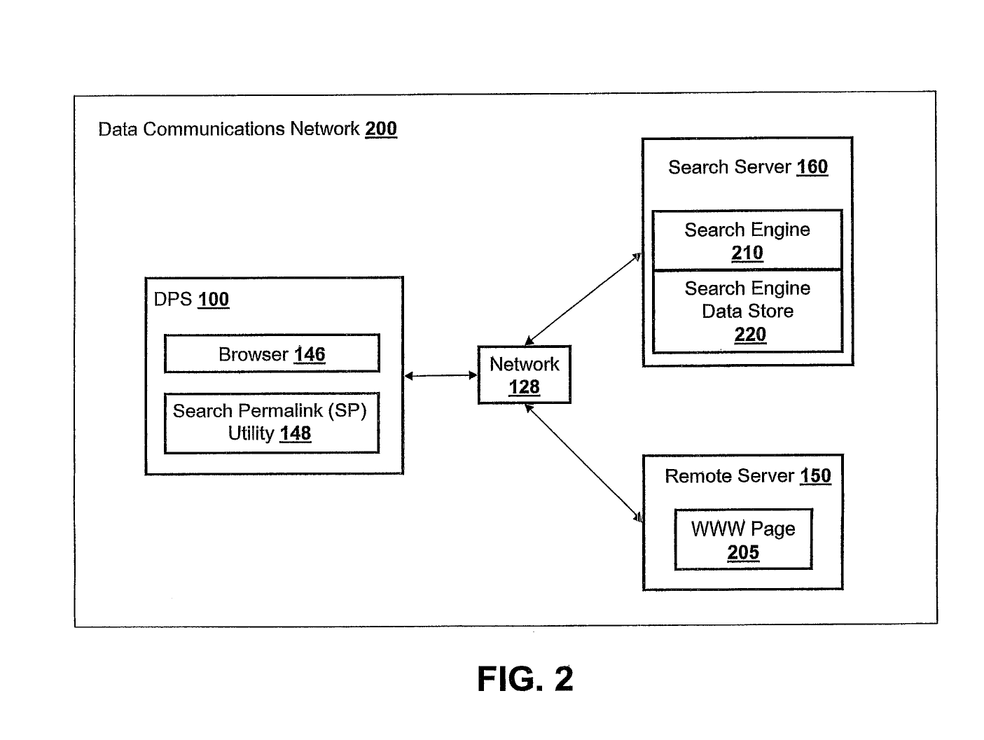

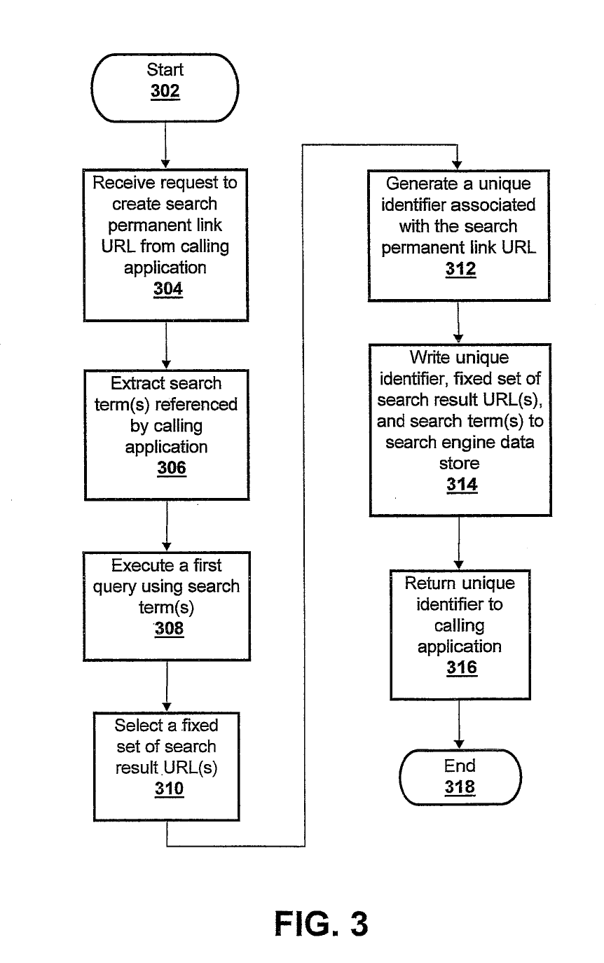

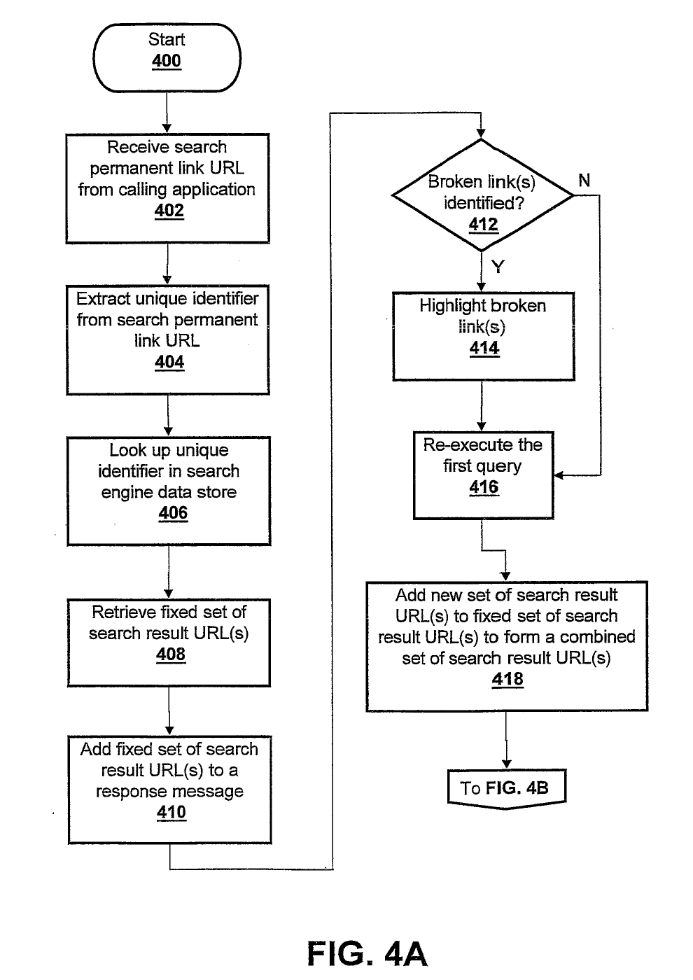

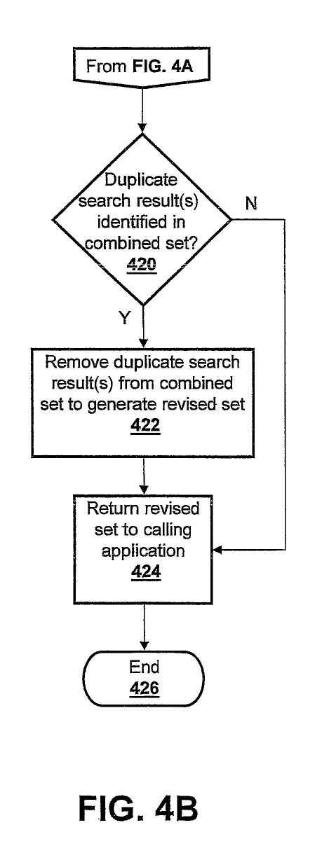

Application programs 144 include browser 146. Browser 146 includes program modules and instructions enabling a World Wide Web (WWW) client (i.e., DPS 100 or search server 160) to send and receive network messages to the Internet. DPS 100 may utilize HyperText Transfer Protocol (HTTP) messaging to enable communication with remote server 150 and search server 160. Application programs 144 in system memory 136 also include a Search Permalink (SP) utility 148. SP utility 148 performs the functions illustrated below in FIGS. 3 and 4A-4B, and may include all logic, helper functions, databases and other resources depicted below in FIG. 2. SP utility 148 processes electronic signals from a multitude of sources, such as remote server 150 and search server 160 in network 128, as well as from other application programs 144. In actual implementation, application programs 144, browser 146, and SP utility 148 may be combined as a single application collectively providing the various functions of each individual software component when the corresponding code is executed by processor unit 104. For simplicity, SP utility 148 is illustrated and described as a stand alone or separate software/firmware component, which provides specific functions, as described below. Processor unit 104 executes SP utility 148, browser 146, as well as OS 138, which supports the user interface features of SP utility 148.

FIG. 2 shows a data communications network 200, which incorporates some of the components described in FIG. 1. Data communication network includes network (e.g., Internet) 128 (FIG. 1). Connected to network 128 is remote server 150 (FIG. 1). Stored in remote server 150 is a World Wide Web (WWW) page 205. Search server 160 (FIG. 1) is also connected to network 128. Stored in search server 160 is search engine 210 and search engine data store 220. Search engine data store 220 includes URLs, keywords, and extracts, corresponding to WWW pages, such as WWW page 205, stored on remote server 150. Search engine data store 220 also contains, against each WWW page listed therein, hypertext links from other WWW pages to the WWW page. Also connected to network 128 is DPS 100 (FIG. 1), which, according to one embodiment, serves as a user terminal. Stored in DPS 100 is browser 146 (FIG. 1), for enabling DPS 100 to access WWW page 205 residing on remote server 150.

In operation, a user of DPS 100 wishing to employ search engine 210 to search network 128 for WWW pages relating to a particular topic initially accesses search engine 210 on search server 160 by inputting the URL of search engine 210 to browser 146. On receipt of the URL, browser 146 sends a request for search engine 210 via network 128 to search server 160. On remote server's 30 receipt of the request from browser 146, search server 160 retrieves and activates search engine 210. On activation, search engine 210 returns, via network 128, and input field to browser 146 in DPS 100 for display to a user. The user enters a textual search parameter (i.e., search term) such as a key word or words into the input field displayed in browser 146. Browser 146 returns the search argument entered by the user back to search engine 210 running on search server 160 via network 128. On receipt of the search term, search engine 210 searches search engine data store 220 for keywords matching the search term. When a match is found, search engine 210 retrieves the corresponding URL from search engine data store 220. Search engine 210 thus generates a list of URLs corresponding to WWW pages matching the search term. Search engine 210 adds to the list the URLs of any WWW pages containing pointers to the WWW pages identified by the search term search.

Among the software code/instructions provided by SP utility 148, and which are specific to the invention are: (a) code for receiving a request to create a search permanent link URL from a calling application (i.e., browser 146); (b) code for extracting at least one search term referenced by the calling application; (c) code for executing a first query using the at least one search term; (d) code for selecting a fixed set of at least one search result URL from the executing the first query step; (e) code for generating a unique identifier associated with the search permanent link URL; (f) code for writing the unique identifier, the fixed set of the at least one search result URL, and the at least one search term to a search engine data store; (f) code for returning the unique identifier to the calling application; (g) code for receiving the permanent link URL from the calling application; (h) code for extracting the unique identifier from the permanent link URL; (i) code for looking up the unique identifier in search engine data store 220; (j) code for retrieving the fixed set of the at least one search result URL; (k) code for adding the fixed set of the at least one search result URL to a response message; (l) code for verifying the fixed set of the at least one search result URL to identify at least one broken link within the fixed set; (m) code for highlighting the at least one broken link within the fixed set in response to identifying the at least one broken link; (n) code for re-executing the first query from which the search permanent link is based on for yielding a new set of the at least one search result URL; (o) code for adding the new set to the fixed set to generate a combined set of the at least one search result URL; (p) code for removing a duplicate search result URL from the combined set of the at least one search result URL to generate a revised set of the at least one search result URL; and (q) code for returning the revised set of the at least one search result URL to the calling application. For simplicity of the description, the collective body of code that enables these various features is referred to herein as SP utility 148. According to the illustrative embodiment, when processor unit 104 executes SP utility 148, DPS 100 initiates a series of functional processes that enable the above functional features as well as additional features/functionality, which are described below within the description of FIGS. 3-4B.

Those of ordinary skill in the art will appreciate that the hardware elements depicted in DPS 100 are not intended to be exhaustive, but rather represent and/or highlight certain components that may be utilized to practice the present invention. For example, other devices/components may be used in addition to or in place of the hardware depicted. The depicted example is not meant to imply architectural limitations with respect to the present invention. These and other variations are intended to be within the spirit and scope of the present invention.

FIGS. 3-4B are flow-charts illustrating various methods by which the above processes of the illustrative embodiments are completed. Although the methods illustrated in FIGS. 3-4B may be described with reference to components shown in FIGS. 1-2, it should be understood that this is merely for convenience and alternative components and/or configurations thereof can be employed when implementing the various methods. Key portions of the methods may be completed by SP utility 148 executing within DPS 100 (FIG. 1) and controlling specific operations on DPS 100, search server 160, and the methods are thus described from the perspective of SP utility 148, browser 146, DPS 100, and/or search server 160.

The process of browser 146 creating a new permanent link in search engine data store 220 is described in the flow-chart of FIG. 3. The process of FIG. 3 begins at initiator block 302 and proceeds to block 304, at which search engine 210 (FIG. 2) receives a request to create a search permanent link URL from a calling application, such as browser 146 (FIG. 1). As depicted in block 306, search engine 210 extracts at least one search term that is referenced by the calling application. Search engine 210 executes a first query using the one or more search terms, as depicted at block 308. Upon the completion of execution of the first query, search engine 210 selects a fixed set of at least one search result URL(s) that are outputted from the execution of the first query, as depicted in block 310. According to one embodiment, the actual number of search result URLs that are selected by search engine 210 can be modified by a search engine user.

As depicted in block 312, search engine 210 generates a unique identifier associated with the search permanent link URL. The unique identifier may be encoded in several different ways. In one embodiment, the unique identifier is a unique value that is placed as a query parameter in the search permanent link URL: http://www.google.com/permalinks?id=123456789 (i.e., “123456789” is the unique value). In another embodiment, the unique identifier includes search terms along with other meta-data, such as a date/time stamp: http://www.google.com/permalinks?terms=tennis+federer&date=29022008&time=1312 (“tennis” and “federer” are the search terms; 29022008 is the date; 1312 is the time). In both exemplary embodiments, the query parameters are combined together into a string and then hashed to produce the unique identifier for the permanent link. The unique identifier, the fixed set of search result URL(s), and the search term(s) are written to search engine data store 220 (FIG. 2), as depicted in block 314. The unique identifier is returned to the calling application, as depicted in block 316. The process ends at termination block 318.

The process of browser 146 retrieving a permanent link from search engine 210 is described in the flow-chart of FIGS. 4A-4B. The process of FIG. 4A begins at initiator block 400 and proceeds to block 402, at which search engine 210 receives the search permanent link URL from the calling application. As depicted in block 404, search engine 210 extracts the unique identifier from the search permanent link URL. The unique identifier is used by search engine 210 as a lookup key to access the permanent link URL that is written in search engine data store 220. As depicted in block 406, search engine 210 looks up the unique identifier in search engine data store 220. Search engine 210 retrieves the fixed set of search result URL(s), as depicted in block 408. As depicted in block 410, the fixed set of search result URL(s) are added to a response message (e.g., a HyperText Transfer Protocol (HTTP) message). According to one embodiment, if search engine 210 detects that a link has moved, search engine 210 updates the search results referenced by search permanent link URL, such that the search results are maintained up to date.

Once the fixed set of search result URL(s) have been added to the response message, search engine 210 verifies whether one or more of the search result URL(s) forming the fixed set is associated with a broken link, as depicted in decision block 412. If a broken link is identified, search engine 210 highlights the broken link within the fixed set of search result URL(s), as depicted in block 414. According to another embodiment, search engine 210 provides the content that had been previously referenced by the broken link from search engine's 210 content cache. However, if no broken link is identified, the method continues to block 416 (described below). As depicted in block 416, search engine 210 re-executes the first query from which the search permanent link URL is based. The re-execution of the first query yields a new set of search result URL(s). The new set of search result URL(s) is added to the fixed set to generate a combined set of the search result URL(s), as depicted in block 418. The method continues to block 420 at FIG. 4B.

Referring now to FIG. 4B, at decision block 420, search engine 210 determines whether there are any duplicate search result URL(s) within the combined set of search result URL(s). If no duplicate search result URL(s) is/are identified, the method continues to block 424, which is described below. However, if duplicate search result URL(s) is/are identified, search engine 210 removes the duplicate search result URL(s) from the combined set to generate a revised set of one or more search result URLs, as depicted in block 422). From block 422, the method continues to block 424. As depicted in block 424, search engine 210 returns the revised set of search result URL(s) to the calling application. The process ends at termination block 426.

In the flow charts above, one or more of the methods are embodied as a computer program product in a computer readable medium or containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

Note that the flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As will be further appreciated, the processes in embodiments of the present invention may be implemented using any combination of software, firmware or hardware. As a preparatory step to practicing the invention in software, the programming code (whether software or firmware) will typically be stored in one or more machine readable storage mediums such as fixed (hard) drives, diskettes, optical disks, magnetic tape, semiconductor memories such as ROMs, PROMs, etc., thereby making an article of manufacture (or computer program product) in accordance with the invention. The article of manufacture containing the programming code is used by either executing the code directly from the storage device, by copying the code from the storage device into another storage device such as a hard disk, RAM, etc., or by transmitting the code for remote execution using transmission type media such as digital and analog communication links. The methods of the invention may be practiced by combining one or more machine-readable storage devices containing the code according to the present invention with appropriate processing hardware to execute the code contained therein. An apparatus for practicing the invention could be one or more processing devices and storage systems containing or having network access to program(s) coded in accordance with the invention.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a computer program product in a variety of forms, and that an illustrative embodiment of the present invention applies equally regardless of the particular type of media used to actually carry out the distribution. By way of example, a non exclusive list of types of media, includes recordable type (tangible) media such as floppy disks, thumb drives, hard disk drives, CD ROMs, DVDs, and transmission type media such as digital and analogue communication links.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

1. A method of encoding search results as a search permanent link Uniform Resource Locator (URL), said method comprising:
receiving a request to create said search permanent link URL from a calling application, wherein said search permanent link URL references at least one search result URL derived from a search engine;
extracting at least one search term referenced by said calling application;
executing a first query using said at least one search term;
selecting a fixed set of said at least one search result URL from said executing said first query step;
generating a unique identifier associated with said search permanent link URL;
writing said unique identifier, said fixed set of said at least one search result URL, and said at least one search term to a search engine data store;
returning said unique identifier to said calling application;
receiving said search permanent link URL from said calling application;
extracting said unique identifier from said search permanent link URL;
looking up said unique identifier in said search engine data store;
retrieving said fixed set of said at least one search result URL;
adding said fixed set of said at least one search result URL to a response message;
verifying said fixed set of said at least one search result URL to identify at least one broken link within said fixed set;
in response to identifying said at least one broken link, highlighting said at least one broken link within said fixed set;
re-executing said first query from which said search permanent link URL is based on for yielding a new set of said at least one search result URL;
adding said new set to said fixed set to generate a combined set of said at least one search result URL;
removing a duplicate search result URL from said combined set of said at least one search result URL to generate a revised set of said at least one search result URL;
returning said revised set of said at least one search result URL to said calling application.
